(19) United States
(12) Patent Application Publication
(10) Pub. No.: US 2023/0110874 A1
(43) Pub. Date: Apr. 13, 2023

(54) O2 Tree for Addressing Climate Change

(71) Applicant: Jocelyn Bruno, Cibolo, TX (US)

(72) Inventor: Jocelyn Bruno, Cibolo, TX (US)

(21) Appl. No.: 17/521,833

(22) Filed: Nov. 8, 2021

Related U.S. Application Data
(63) Continuation-in-part of application No. 17/496,596, filed on Oct. 7, 2021.

(51) Int. Cl. B01D 53/62; B01D 53/04

(52) U.S. Cl. CPC B01D 53/62; B01D 53/04; B01D 2257/504; B01D 2252/204; B01D 2253/102

(57) ABSTRACT

An article of manufacture for providing an O₂ Tree for removing CO₂ gas from the atmosphere according to the present invention is disclosed.

### TECHNICAL FIELD

This application relates in general to an article of manufacture for providing an environmental treatment device, and more specifically, to an article of manufacture for providing an 02 Tree for removing CO2 gas from the atmosphere.

### BACKGROUND

Greenhouse gases trap heat and make the planet warmer. According to the U.S. Environmental Protection Agency (EPA), human activities are responsible for nearly all the increase in greenhouse gases in our atmosphere over the last 150 years.—Since 1990, gross U.S. greenhouse gas emissions have increased by 2 percent The largest source of greenhouse gas emissions from human activities in the U.S. is from burning fossil fuels for electricity, heat, and transportation. Land areas can act as a sink (absorbing CO2 from the atmosphere) or a source of greenhouse gas emissions. Since 1990 in the U.S., managed forests and other lands are a net sink; they have absorbed more CO2 from the atmosphere than they emit. With this in mind, We can manufacture artificial “trees” to be used in populated areas to absorb CO2 from the atmosphere and release 02.

Therefore, a need exists for an article of manufacture for providing an 02 Tree for removing CO2 gas from the atmosphere. The present invention attempts to address the limitations and deficiencies in prior solutions according to the principles and example embodiments disclosed herein.

### SUMMARY

In accordance with the present invention, the above and other problems are solved by providing an article of manufacture for an 02 Tree for removing CO2 gas from the atmosphere according to the principles and example embodiments disclosed herein.

In one embodiment, the present invention is an article of manufacture for providing an 02 Tree for removing CO2 gas from the atmosphere. The 02 Tree includes a capture chamber having a C02/02 processing unit, an intake port into the capture chamber, an exhaust port from the capture chamber, and the C(h/02 processing unit having a captured CO2 transfer port. The C02/02 processing unit includes a fan having a fan motor for moving air into and out of the capture chamber through the intake port and the exhaust port, a filter element for binding with the CO2 within the capture chamber and a controller. The controller being configured to cause the C(}j(h processing unit to open the intake port and the exhaust port, and activate the fan motor to draw atmospheric air into the C02/02 processing unit.

In another aspect of the present invention, the filter element utilizes graphene to bind the CO2 to the filter element.

In another aspect of the present invention, the 02 Tree further includes a solar power dome having one or more solar power arrays, a power supply for suppling electrical power to the 02 Tree, and one or more rechargeable batteries.

In another aspect of the present invention, the power supply recharges the one or more rechargeable batteries using the solar arrays.

In another aspect of the present invention, the power supply recharges the one or more rechargeable batteries using an external AC power source.

In another aspect of the present invention, the power supply uses the rechargeable batteries to provide electrical power to the 02 Tree when the external AC power source is unavailable.

In another aspect of the present invention, the CO2 passing out of the capture chamber is passed to an external waste CO2 storage network.

In another aspect of the present invention, the external waste CO2 storage network comprises a piping network to deposit the waste CO2 into below ground rock formations.

In another aspect of the present invention, the CO2 passing out of the capture chamber is passed to a storage container.

In another aspect of the present invention, the storage container contains a polyethyleneimine material to bond with the, waste CO2 for storage.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates example embodiments of an article of manufacture providing a device for removing CO2 gas from the atmosphere according to the present invention.

FIG. 2 illustrates another example embodiment of an article of manufacture providing an 02 Tree for removing CO2 gas from the atmosphere according to the present invention.

FIG. 3 illustrates additional example embodiments of the article of manufacture providing an 02 Tree for removing CO2 gas from the atmosphere according to the present invention.

FIG. 4 illustrates a block diagram of an article of manufacture showing example embodiments of an article of manufacture providing an 02 Tree for removing CO2 gas from the atmosphere according to the present invention.

### DETAILED DESCRIPTION

This application relates in general to an article of manufacture for providing an environmental treatment device, and more specifically, to an article of manufacture providing an 02 Tree for removing CO2 gas from the atmosphere according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture providing a device for removing CO2 gas from the atmosphere according to the present invention. The term user herein refers to one or more users.

The term “invention” or “present invention” refers to the invention being applied for via the patent application with the title “02 Tree for Addressing Climate Change.” Invention may be used interchangeably with CO2 device.

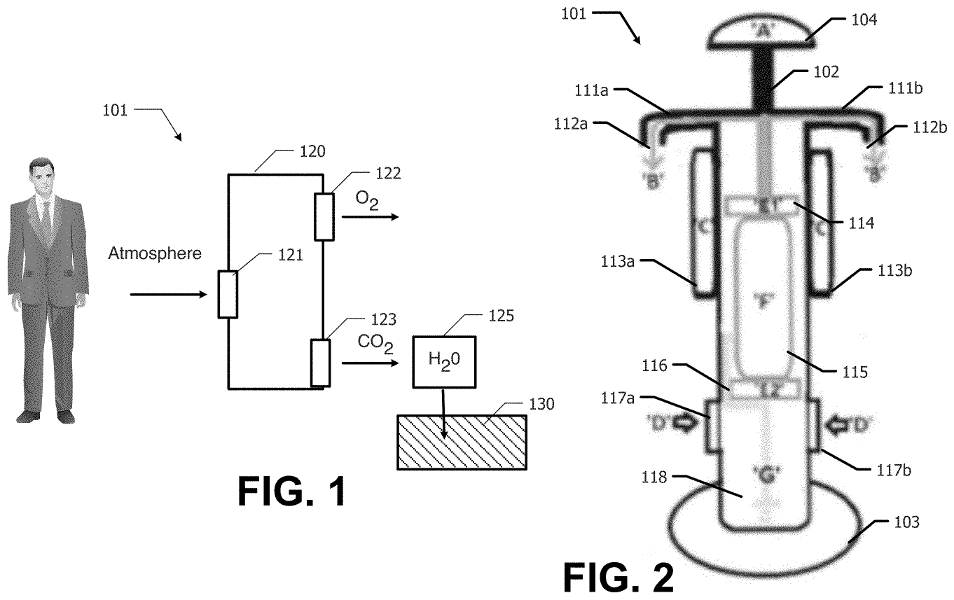

In general, the present disclosure relates to an article of manufacture providing an 02 Tree for removing CO2 gas from the atmosphere according to the present invention. To better understand the present invention, FIG. 1 illustrates example embodiments of an article of manufacture providing a device for removing CO2 gas from the atmosphere according to the present invention. The 02 Tree 101 is a small device that is similar in size to a large individual permitting the 02 Trees to be located throughout a region inhabited by people. The 02 Tree 101 is intended to be installed nationwide throughout all cities, towns, and residential neighborhoods, operating 24/7 to filter out CO2 and deliver 02.

An 02 Tree 101 is a device designed to suck in air containing carbon dioxide (C(},), direct the captured CO2 to the earth, and output oxygen (O?). The 02 Tree 101 is built in a manner pleasing to the eye, and yet able to capture C_{(}}, and output Ch at a far greater volume than real trees. The 02 Tree 101 may operate on AC power and in the event of AC power failure, a rechargeable battery may be used to provide power for continued operation until AC power is restored In the event of extended AC power loss, the rechargeable battery powers the unit until battery power is depleted to 10° 1;), at which point. the Ch Tree 101 powers down to allow the rechargeable battery to charge to 95% Once the 02 Tree 101 reaches this threshold, the 02 Tree 101 powers up again. This CO2 extraction processing cycle repeats until AC power is restored. In this manner, the 02 Tree 101 ensures continued daily operation with off periods for battery recharging.

The 02 Tree 101 operates by drawing atmospheric air into the device 101 through an input port 121. The atmospheric air includes both Ch and CCh gases as well as other elements.

The 02 Tree 101 extracts the CO2 from the atmospheric air and passes the CO2 through a captured C(h output port 123 to be mixed with water 125. The Ch gas and other constituent elements are expelled out a separate exhaust port 122. The water, having dissolved the CO2 gas contained therein, may be stored into rock formations 130 for long term storage. Additional details regarding the 02 Tree 101 are described below in reference to FIG. 2.

FIG. 2 illustrates another example embodiment of an article of manufacture providing an 02 Tree for removing CO2 gas from the atmosphere according to the present invention. The example embodiment of an (} Tree 101 shown in FIG. 2 is constructed using an internal frame structure 102, a support base 103, a solar power dome 104, and a pair of treated air exhaust lines 111a-b, each having its own exhaust port 112a-b. The 02 Tree 101 further comprises a pair of rechargeable batteries 113a-b, a controllable exhaust fan 114, a CO2/O2 processing unit 115, a controllable intake fan 116, a pair of intake ports 117a-b, and a CO2 storage unit 118.

The internal frame structure 102 supports ail of the components within the Ch Tree 101 as well as provides a path through the 02 Tree 101 as the CO2 is extracted from the air and processed for storage. The internal frame structure 102 also provides a path for the processed 02 gas to reach the external exhaust ports 112a-b for returning the processed 02 gas to the atmosphere.

The support base 103 is connected to the internal frame structure 102 to orient the 02 Tree 101 into a desired position. The support base 103 also may include connections to external devices including external power and waste water containing the dissolved CO2 gas for storage.

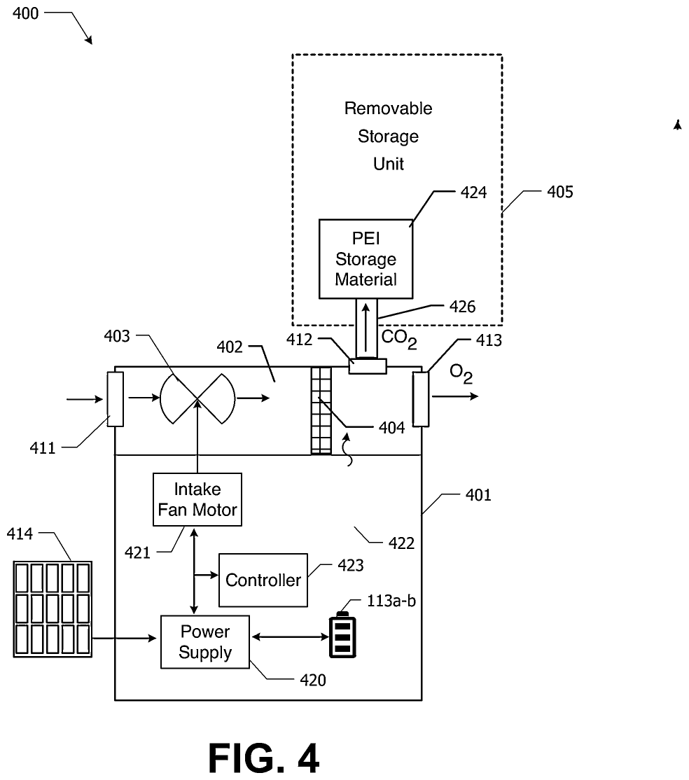

The solar power dome 104 is a solar array support containing one or more solar array devices as shown in FIG. 4 that provide electrical power to recharge the rechargeable batteries 113a-b as well as provide a backup power source to power the 02 Tree 101 when AC power from an external source is unavailable. The solar power dome 104 may possess any shape that supports the solar arrays 414 and directs the solar arrays toward the sun as needed.

The pair of treated air exhaust lines 111a-b, each having its own exhaust port 112a-b, is connected to the controllable exhaust valve 114 to permit the processed gas to be vented out of the exhaust ports 112a-b into the surrounding environment.

The pair of rechargeable batteries 113a-b store electrical energy that may be used to power the Ch Tree 101 when external power in not available. The pair of rechargeable batteries 113a-b may be charged using the external power source when it is available and may be charged by the solar arrays 414 coupled to the solar power dome 104.

The controllable exhaust fan 114 operates to move the processed air to flow to the exhaust ports 112a-b. As disclosed in more detail in reference to FIG. 4, the atmospheric air is passed into the CO2/O2 processing unit 115 where the CO2 gas is captured. The CO2/O2 processing unit 115 to vents the captured C(h gas into the C(} storage unit 118 for further processing for long term storage.

The CCh/Ch processing unit 115 accepts atmospheric air to capture and separate the CO2 contained within the atmospheric air before venting the processed air through the exhaust ports 112a-b. The CO2/O2 processing unit 115 utilizes one of several CO2 capture and separation technologies currently being developed. For example, Chemical engineers Sahag Voskian and T. Alan Hatton of the Massachusetts Institute of Technology developed the carbon capture approach, which works by passing the air to be filtered through a stack of special charged plates.

In its operating principle, the device is somewhat like a battery—but one that absorbs carbon dioxide passing over its electrodes as it charges and subsequently releases the collected greenhouse gas as it discharges. Other technologies may work as well. See https:/ [symbol] .dailymail.co.uk/sciencetech/article-76265851Revolutionary-air-filtering-device-absorbs-carbon-dioxide-concentration-level_. [symbol] _

The controllable intake fan 116 controls the intake flow of atmospheric air from the environment through the intake ports 117a-b into the C02/02 processing unit 115. The controllable intake fan 116 works with the controllable exhaust fan 114 to control the flow of air through the C02/02 processing unit 115 as the CO2 gas is extracted and vented into the storage unit 118.

The pair of intake ports 117a-b passes atmospheric air into the 02 Tree 101 in order to extract the CO2. The pair of intake ports 117a-b is coupled to the controllable intake valve 116 creating a path to the C02/02 processing unit 115. Once the C02/02 processing unit 115 has captured a sufficient amount of CO2 gas, the controllable exhaust fan 114 and the controllable intake fan 116 are deactivated and the captured CO2 gas is stored within the CO2 storage unit 118.

The CO2 storage unit 118 is coupled to the C02/02 processing unit 115 to accept the vented CO2 gas for further processing and storage. Disposing of the vented CO2, may be accomplished in several ways. In a preferred embodiment, the vented CO2 gas is captured within a material called polyethyleneirnine, or PEI, acts like a Carbon dioxide fly tape trap. Once the PEI material is saturated with CO2, The 02 Tree 101 may be routinely services with the CO2 storage unit 118 removed and a fresh storage unit installed in its place. The captured CO2 in the PEI material may be processed to release the CO2 gas within a recycling facility in which the CO2 gas may be saved for industrial uses or processed for long term storage.

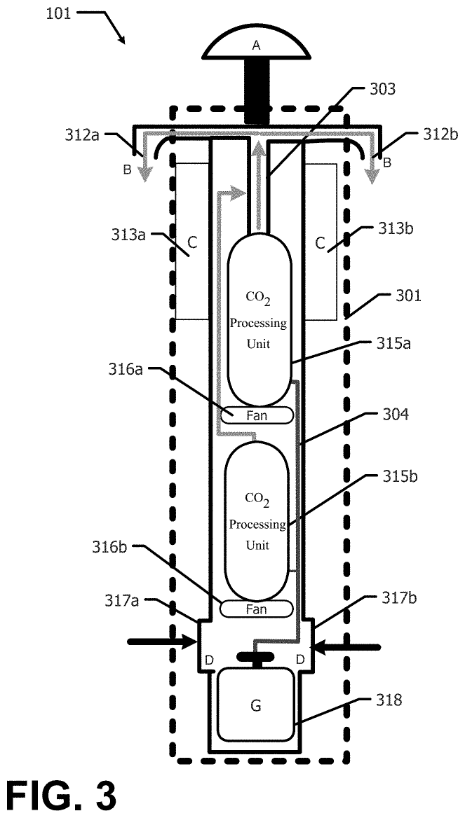

FIG. 3 illustrates additional example embodiments of the article of manufacture providing an 02 Tree 101 for removing CO2 gas from the atmosphere according to the present invention. FIG. 3 shows the article of manufacture providing an 02 Tree 101 for removing CO2 gas from the atmosphere according to the present invention. The 02 Tree 101 shown in FIG. 3 includes a cylindrical casing 301 around all of the components described above in reference to FIG. 2. The cylindrical casing 301 includes an access door that may open 180 degrees to allow easy access to all components and provide access to the CO2 storage unit 118 for servicing. The cylindrical casing 301 also protects individuals near the 02 Tree 101 during operation. This embodiment of the 02 Tree 101 uses a pair of CO2/Ch processing unit 325a-b and a pair of controllable intake fans 114a-b to move atmospheric air in from the intake ports 317a-b, through the intake fans 114a-b, and into one of the CO2/O2 processing unit 115a-b. Processed air exits the CO2/O2 processing units 115a-b to be vented through an exhaust line 303 from the top of each of the two CO2/(} processing units 115a-b to the exhaust ports 312a-b. This embodiment of the 02 Tree 101 is powered in a manner similar to the embodiment of FIG. 2 and may utilize batteries 313a-b when external power is unavailable.

FIG. 3 illustrates an additional example embodiment of the article of manufacture providing an 02 Tree for removing CO2 gas from the atmosphere having a capture container according to the present invention. In this alternate embodiment, the captured CO2 is pumped into storage tanks. A vendor comes and pick up the full tanks at regular intervals and deliver to companies that use CO2 to manufacture useful products or treated as some biohazard material and delivered to an appropriate facility for proper disposition.

One efficient and cost-effective approach to the disposal of the CO2 exiting the C(h filter. A material called poiyethyleneimine, or PEI, acts like a Carbon dioxide fly tape trap, attracting the greenhouse-gas molecules and sticking to them so they can't escape. No pressurization is required, we simply route the CO2 to a container 320 that contains a specified amount of the polyethyleneimine material housed at base of machine. Calculations will need to be made to determine how much of the polyethyleneimine material goes into the container. This is important because, with machine operating 24/7, we want to build that container such that the container becomes saturated in 1, 2, 3, or however many months before becoming saturated, so vendor doing routes know when to pick up and replace the container.

LTnlike other materials that require huge amount of energy to release captured CO2, “One of the advantages of the new material is that it can be reused. Once the material is saturated with carbon dioxide, it is heated to a relatively low temperature of 85 degrees C. (185 degrees F.). At that temperature, the carbon dioxide is released and can be stored. The carbon can then be used to create fuel. Other materials also are able to release carbon for storage, but according to P.x. k sh and Qg_q?J?. r.t those other materials need to be heated to very high temperatures—700 or 800 degrees C. (1,292 or 1,472 degrees F.)—which requires a great deal of energy and, therefore, a large amount of carbon in the form of fossil fuels.”

It is still important to have the filter built to fit inside Ch Tree 101 because the filter will deliver CO2 to the container at the base of 02 Tree 101 containing that chemical to trap CO2 at huge volumes, as compared to simply pumping ambient air directly into container 320. The present invention has a single 02 Tree 101 to process CO2 at a rate greater than perhaps 200 or more typical leafy trees. This volume of CO2 extraction may then increase that amount exponentially by putting additional CO2 filtration devices inside the 02 Tree 101.

Other methods of extraction and disposal of CO2. may soon include an Artificial Photosynthesis material expected on the market in the near future. When that material becomes available, it will be an easy upgrade to route CO2 from filtering devices to Artificial Photosynthesis material mounted to exterior of 02 Tree 101.

FIG. 4 illustrates a block diagram of an article of manufacture providing an 02 Tree 400 for removing CO2 gas from the atmosphere according to the present invention. One embodiment of an 02 Tree 400 is constructed using an enclosed container 401 having a CO2 filtering chamber 402 with a fan 403 driven by a fan motor 421 to direct atmospheric air into an intake port 411 and through a filter element 404 in the CO2 processing unit. The filter element 404 includes a CO2 separation and extraction processing unit to remove the CO2 from the atmospheric air.

The filtered air having the CO2 removed is expelled as exhaust out of an exhaust port 413. When the filter element 404 has captured the CO2, the intake port 411 and exhaust port 413 are closed. A captured CO2 transfer port 412 may be opened to force the CO2 into a CO2 storage unit 405. The captured CO2 transfer port 412 is closed when the CO2 storage unit 405 is saturated with CO2.

The 02 Tree 101 is powered by a power supply 420 that is coupled to an external source (not shown), the solar array 414, and one or more rechargeable battery 113a-b. As described above, the power supply 420 will typically operate using the external AC power. When the external source is not available, the rechargeable batteries 113a-b may provide power to operate the 02 Tree 101. The power supply 420 can recharge the batteries 113a-b using the external source when available and the solar array 414 when needed.

A controller 423 commands the operation of the components within the 02 Tree 101. The controller 423 sends control signals to the intake port 411, the exhaust port 413, the captured CO2 transfer port 412, and the fan motor 421 to operate and close as needed. The controller 423 comprises an electronic device configured to control the operating state of the intake port 411, the exhaust port 413, and the captured CO2 transfer port 412, and the fan motor 421, throughout the CO2 extraction processing cycle described above.

The CO2 storage unit 405 is contains the PEI material to capture and store the CO2 gas until the 02 tree 400 is routinely services with a fresh CO2 storage unit 405. Once a fresh CO2 storage unit 405 is installed, the 02 tree 400 operates until the PEI material in the CO2 storage unit 405 is again saturated and the process repeats.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing an O₂ tree for removing CO₂ gas from the atmosphere, the O₂ tree comprises:
a capture chamber having a CO₂/O₂ processing unit;
a CO₂ storage unit;
an intake port into the capture chamber;
an exhaust port from the capture chamber; and
the CO₂/O₂ processing unit comprises:
a captured CO₂ transfer port;
a fan having a fan motor for moving air into and out of the capture chamber through the intake port and the exhaust port;
a filter element for binding with the CO₂ within the capture chamber;
a controller, the controller configured to cause the CO₂/O₂ processing unit to:
open the intake port and the exhaust port;
activate the fan motor to draw atmospheric air into the capture chamber;
monitor the saturation of the CO2 in storage material within the CO2 storage unit.

2. The O₂ tree according to claim 1, wherein the filter element utilizes graphene to bind the CO₂ to the filter element.

3. The O₂ tree according to claim 1, wherein the O₂ Tree further comprises:
a solar power dome having one or more solar power arrays;
a power supply for suppling electrical power to the O₂ Tree; and
one or more rechargeable batteries.

4. The O₂ tree according to claim 3, wherein the power supply recharges the one or more rechargeable batteries using the solar arrays.

5. The O₂ tree according to claim 3, wherein the power supply recharges the one or more rechargeable batteries using an external AC power source.

6. The O₂ tree according to claim 5, wherein the power supply uses the rechargeable batteries to provide electrical power to the O₂ Tree when the external AC power source is unavailable.

7. The O₂ tree according to claim 1, wherein the CO₂ passing out of the capture chamber is passed to an external waste CO₂ storage network.

8. The O₂ tree according to claim 7, wherein the external waste CO₂ storage network comprises a piping network to deposit the waste CO₂ into below ground rock formations.

9. The O₂ tree according to claim 1, wherein the CO₂ passing out of the capture chamber is passed to a storage container.

10. The O₂ tree according to claim 9, wherein the storage unit contains a polyethyleneimine material to bond with the waste CO₂ for storage.
